(19) United States
(12) Patent Application Publication
(10) Pub. No.: US 2025/0322659 A1
(43) Pub. Date: Oct. 16, 2025

(54) VIDEO BASED UNSUPERVISED LEARNING OF PERIODIC SIGNALS

(71) Applicants: Securiport LLC, Reston, VA (US); University of Notre Dame du Lac, South Bend, IN (US)

(72) Inventors: Jeremy SPETH, South Bend, IN (US); Nathan VANCE, South Bend, IN (US); Patrick FLYNN, South Bend, IN (US); Adam CZAJKA, South Bend, IN (US); Nathan CARPENTER, Reston, VA (US); Juan Manuel SEGURA, Reston, VA (US)

(21) Appl. No.: 19/175,472

(22) Filed: Apr. 10, 2025

Related U.S. Application Data
(60) Provisional application No. 63/632,112, filed on Apr. 10, 2024.

(51) Int. Cl. G06V 20/40; G06V 10/82; G06V 20/52

(52) U.S. Cl. CPC G06V 20/41; G06V 10/82; G06V 20/52

(57) ABSTRACT

The disclosure introduces systems, devices, methods, and instructions for autonomously identifying recurring patterns (e.g., pulse, respiration) in video content using unsupervised learning. The embodiments overcome the limitations of traditional supervised methods that require extensive labeled datasets, particularly for detecting subtle periodic signals like heart rate and respiration. The disclosure utilizes feature extraction, clustering algorithms, and validation to analyze video data for these temporal patterns, offering potential applications in various fields such as border or gate security, deception detection, healthcare, and entertainment without the need for manual annotation.

### PRIORITY INFORMATION

This application claims the benefit of U.S. Provisional Patent Application No. 63/632,112 filed on Apr. 10, 2024, which is hereby incorporated by reference in its entirety.

### FIELD

The embodiments of the present invention generally relate the field of video data analysis, and more particularly to the detection and analysis of periodic signals within video content through unsupervised learning techniques. For example, the embodiments can utilize algorithms and machine learning frameworks to autonomously identify recurring patterns and events in video data, thereby facilitating the examination of temporal patterns without the need for labeled datasets.

### BACKGROUND

In general, biometrics can be used to track vital signs that provide indicators about a subject's physical state that can be used in a variety of ways. As an example, for border security or health monitoring, vital signs can be used to screen for health risks (e.g., temperature). While sensing temperature is a well-developed technology, collecting other useful and accurate vital signs such as pulse rate (i.e., heart rate or heart beats per minute) or pulse waveform has required physical devices to be attached to the subject. The desire to perform this measurement without physical contact has produced some video-based techniques, however, these are generally limited in accuracy, require control of the subject's posture, and/or require a close positioning of the camera.

Performing reliable pulse rate or pulse waveform estimation from a camera sensor is more difficult than contact plethysmography for several reasons. The change in reflected light from the skin's surface, because of light absorption of blood, is very minor compared to those caused by changes in illumination. Even in settings with ambient lighting, the subject's movements drastically change the reflected light and overpower the pulse signal.

The field of video data analysis has evolved to address the growing demand for efficient methods of extracting meaningful information from visual content. In particular, the analysis of periodic signals within video data has emerged as an area of significance, given its applications across various domains such as surveillance, border or gate control, deception detection, medical diagnostics, and multimedia entertainment. The extraction and interpretation of these signals can provide insights into recurrent patterns and behaviors that are intrinsic to the understanding of dynamic scenes captured in video format.

Existing technologies in the domain of periodic signal detection predominantly rely on supervised learning techniques, where extensive labeled datasets are employed to train models to recognize specific patterns. These methods often face limitations due to the scarcity of annotated data and the substantial time and expertise required to generate such datasets. Furthermore, predetermined labels may not encompass all possible patterns, leading to oversight of less conspicuous or novel periodic signals.

Approaches to video analysis, while effective in certain contexts, also struggle with the computational burden associated with processing vast amounts of high-resolution video data in real-time. Frequently, these systems do not sufficiently adapt to diverse input types or scale efficiently with the growing complexity and size of video datasets. Moreover, they often fail to generalize across different domains without significant reconfiguration, making them less versatile in handling varying environmental conditions.

What is needed is a method and system that can autonomously learn and identify periodic signals in video data without dependence on labeled training data. Such an approach would mitigate the challenges associated with data annotation, while adapting to diverse video types and varying conditions. Additionally, what is needed is a method and system that is computationally efficient, enabling real-time analysis and scalability, thereby optimizing the detection and interpretation of periodic patterns across a wide spectrum of applications.

### SUMMARY

Accordingly, the present invention is directed to unsupervised video processing systems, devices, methods, and instructions for detecting periodic signals that substantially obviates one or more problems due to limitations and disadvantages of the related art.

One object of the embodiments is to provide systems, devices, methods, and instructions for autonomously detecting periodic signals in video data without the requirement for labeled training datasets. This approach enhances the applicability of video analysis in environments where annotated data is scarce, such as in real-time surveillance or medical imaging.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In one aspect, the disclosure relates to a system for detecting periodic signals within video data. The system comprises a video processing unit configured to receive and process video input, a feature extraction module designed to analyze video frames to identify periodic patterns, an unsupervised learning module employing clustering algorithms to group periodic events, and a validation mechanism to assess the accuracy of detected signals using pre-defined metrics.

In another aspect, the feature extraction module includes spatial and temporal filtering components, and can further incorporate a frequency domain transformation to better derive features of repeated events. Another embodiment can involve a dimensionality reduction component within the unsupervised learning module to manage computational complexity and enhance data interpretability.

In yet another aspect, the system can include a visualization interface to present interpretations of the detected periodic signals, allowing users to analyze temporal patterns in a user-friendly manner. The system can be implemented on specialized hardware accelerators, such as GPUs or TPUs, to optimize performance, especially in scenarios requiring real-time or high-resolution video analysis.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates a system for pulse waveform estimation.

FIG. 2 illustrates an overview of a non-contrastive unsupervised learning (SiNC) framework compared with traditional supervised and unsupervised learning.

FIG. 3 illustrates model predictions.

FIG. 4 illustrates preprocessing for remote respiration (left) and pulse estimation (right), along with the bandlimits used during training with SINC.

FIG. 5 illustrates the results for models trained and tested on subject-disjoint partitions from the same datasets.

FIG. 6 illustrates the results for SiNC and supervised training with the same architecture.

FIG. 7 illustrates the results for training and testing on a variety of datasets.

FIG. 8 illustrates the results of training the personalized models.

FIG. 9 is a flowchart illustrating a method for detecting periodic signals within video data.

FIG. 10 is a flowchart detailing an alternative implementation of the method for detecting periodic signals within video data.

FIG. 11 is a flowchart of a system for real-time video analysis of periodic signals.

### DETAILED DESCRIPTION

Reference will now be made in detail to the embodiments of the present invention, examples of which are illustrated in the accompanying drawings. Wherever possible, like reference numbers will be used for like elements.

Embodiments of user interfaces and associated methods for using a device are described. It should be understood, however, that the user interfaces and associated methods can be applied to numerous device types, such as a portable communication device such as a tablet or mobile phone. The portable communication device can support a variety of applications, such as wired or wireless communications. The various applications that can be executed on the device can use at least one common physical user-interface device, such as a touchscreen. One or more functions of the touchscreen as well as corresponding information displayed on the device can be adjusted and/or varied from one application to another and/or within a respective application. In this way, a common physical architecture of the device can support a variety of applications with user interfaces that are intuitive and transparent.

The embodiments of the present invention provide systems, devices, methods, and computer-readable instructions to measure one or more biometrics, including heart-rate and pulse waveform, without physical contact with the subject. In the various embodiments, the systems, devices, methods, and instructions collect, process, and analyze video taken in one or more modalities (e.g., visible light, near infrared, thermal, etc.) to produce an accurate pulse waveform for the subject's heartbeat from a distance without constraining the subject's movement or posture. The pulse waveform for the subject's heartbeat can be used as a biometric input to establish features of the physical state of the subject and how they change over a period of observation (e.g., during questioning or other activity).

Remote photoplethysmography (rPPG) is the monitoring of blood volume pulse from a camera at a distance. Using rPPG, blood volume pulse from video at a distance from the skin's surface can be detected. The embodiments of the invention provide an estimate of the blood volume to generate a pulse waveform from a video of one or more subjects at a distance from a camera sensor. Additional diagnostics can be extracted from the pulse waveform such as heart rate (beats per minute) and heart rate variability to further assess the physiological state of the subject. The heart rate is a concise description of the dominant frequency in the blood volume pulse, represented in beats per minute (bpm), where one beat is equivalent to one cycle.

The embodiments of the present invention (concurrently, simultaneously, in-parallel, etc.) process the spatial and the temporal dimensions of video stream data using a 3-dimensional convolutional neural network (3DCNN). The main advantage of using 3-dimensional kernels within the 3DCNN is the empirical robustness to movement, talking, and a general lack of constraints on the subject. Additionally, the embodiments provide concise techniques in which the 3DCNN is given a sequence of images and produces a discrete waveform with a real value for every frame.

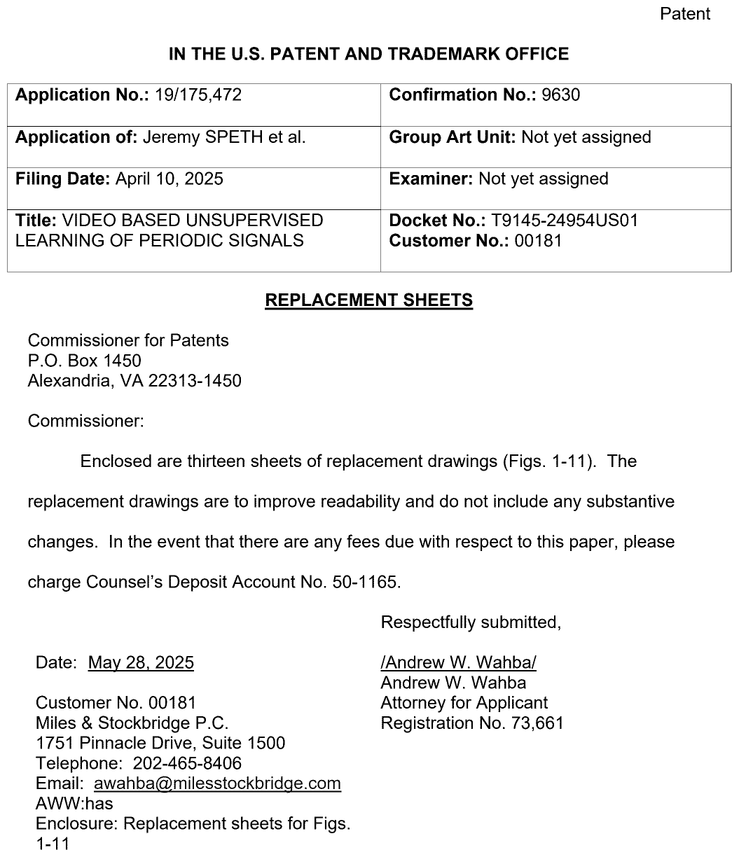

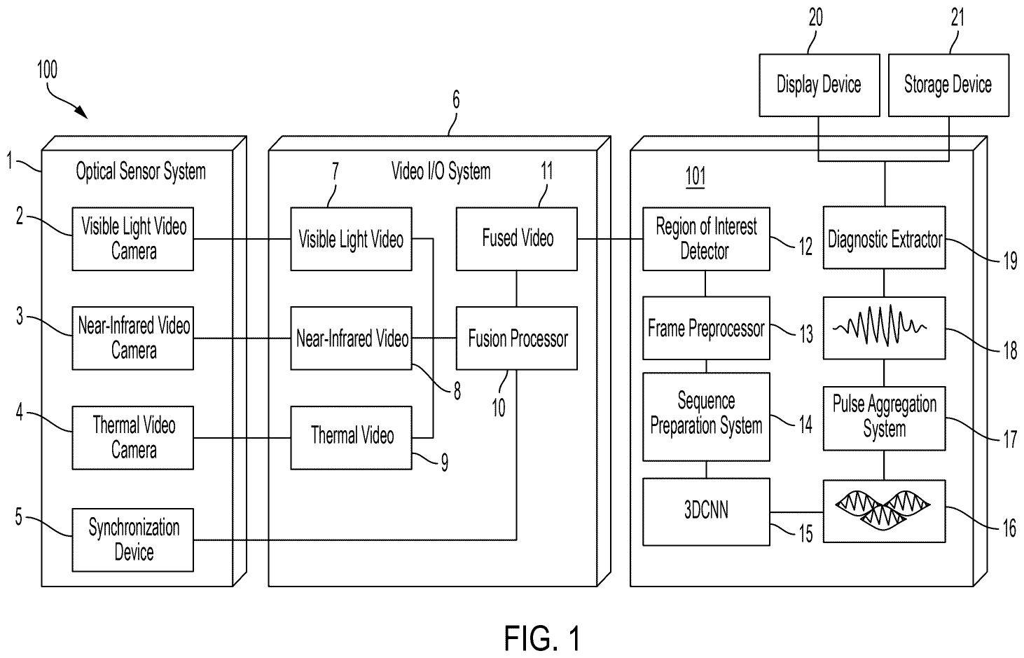

FIG. 1 illustrates a system 100 for pulse waveform estimation. System 100 includes optical sensor system 1, video I/O system 6, and video processing system 101.

Optical sensor system 1 includes one or more camera sensors, each respective camera sensor configured to capture a video stream including a sequence of frames. For example, optical sensor system 1 can include a visible-light camera 2, a near-infrared camera 3, a thermal camera 4, or any combination thereof. In the event that multiple camera sensors are utilized (e.g., single modality or multiple modality), the resulting multiple video streams can be synchronized according to synchronization device 5. Alternatively, or additionally, one or more video analysis techniques can be utilized to synchronize the video streams.

Video I/O system 6 receives the captured one or more video streams. For example, video I/O system 6 is configured to receive raw visible-light video stream 7, near-infrared video stream 8, and thermal video stream 9 from optical sensor system 1. Here, the received video streams can be stored according to known digital format(s). In the event that multiple video streams are received (e.g., single modality or multiple modality), fusion processor 10 is configured to combine the received video streams. For example, fusion processor 10 can combine visible-light video stream 7, near-infrared video stream 8, and/or thermal video stream 9 into a fused video stream 11. Here, the respective streams can be synchronized according to the output (e.g., a clock signal) from synchronization device 5.

At video processing system 101, region of interest detector 12 detects (i.e., spatially locate) one or more spatial regions of interest (ROI) within each video frame. The ROI can be a face, another body part (e.g., a hand, an arm, a foot, a neck, etc.) or any combination of body parts. Initially, region of interest detector 12 determines one or more coarse spatial ROIs within each video frame. Region of interest detector 12 is robust to strong facial occlusions from face masks and other head garments. Subsequently, frame preprocessor 13 crops the frame to encapsulate the one or more ROI. In some embodiments, the cropping includes each frame being downsized by bi-cubic interpolation to reduce the number of image pixels to be processed. Alternatively, or additionally, the cropped frame can be further resized to a smaller image.

Sequence preparation system 14 aggregates batches of ordered sequences or subsequences of frames from frame processer 13 to be processed. Next, 3-Dimensional Convolutional Neural Network (3DCNN) 15 receives the sequence or subsequence of frames from the sequence preparation system 14. 3DCNN 15 processes the sequence or subsequence of frames, by a 3-dimensional convolutional neural network, to determine the spatial and temporal dimensions of each frame of the sequence or subsequence of frames and to produce a pulse waveform point for each frame of the sequence of frames. 3DCNN 15 applies a series of 3-dimensional convolution, averaging, pooling, and nonlinearities to produce a 1-dimensional signal approximating the pulse waveform 16 for the input sequence or subsequences.

In some configurations, pulse aggregation system 17 combines any number of pulse waveforms 16 from the sequences or subsequences of frames into an aggregated pulse waveform 18 to represent the entire video stream. Diagnostic extractor 19 is configured to compute the heart rate and the heart rate variability from the aggregated pulse waveform 18. To identify heart rate variability, the calculated heart rate of various subsequences can be compared. Display unit 20 receives real-time or near real-time updates from diagnostic extractor 19 and displays aggregated pulse waveform 18, heart rate, and heart rate variability to an operator. Storage Unit 21 is configured to store aggregated pulse waveform 18, heart rate, and heart rate variability associated with the subject.

Additionally, or alternatively, the sequence of frames can be partitioned into a partially overlapping subsequences within the sequence preparation system 14, wherein a first subsequence of frames overlaps with a second subsequence of frames. The overlap in frames between subsequences prevents edge effects. Here, pulse aggregation system 17 can apply a Hann function to each subsequence, and the overlapping subsequences added to generate aggregated pulse waveform 18 with the same number of samples as frames in the original video stream. In some configurations, each subsequence is individually passed to the 3DCNN 15, which performs a series of operations to produce a pulse waveform for each subsequence 16. Each pulse waveform output from the 3DCNN 15 is a time series with a real value for each video frame. Since each subsequence is processed by the 3DCNN 15 individually, they are subsequently recombined.

In some embodiments, one or more filters can be applied to the region of interest. For example, one or more wavelengths of LED light can be filtered out. The LED can be shone across the entire region of interest and surrounding surfaces or portions thereof. Additionally, or alternatively, temporal signals in non-skin regions can be further processed. For example, analyzing the eyebrows or the eye's sclera can identify changes strongly correlated with motion, but not necessarily correlated with the photplethysmogram. If the same periodic signal predicted as the pulse is found on non-skin surfaces, it can indicate a non-real subject or attempted security breach.

Although illustrated as a single system, the functionality of system 100 can be implemented as a distributed system. Further, the functionality disclosed herein can be implemented on separate servers or devices that can be coupled together over a network, such as a security kiosk coupled to a backend server. Further, one or more components of system 100 may not be included. For example, system 100 may be a smartphone or tablet device that includes a processor, memory, and a display, but may not include one or more of the other components shown in FIG. 1. The embodiments may be implemented using a variety of processing and memory storage devices. For example, a CPU and/or GPU can be used in the processing system to decrease the runtime and calculate the pulse in near real-time. System 100 can be part of a larger system. Therefore, system 100 can include one or more additional functional modules.

The field of technology addressed herein involves the analysis and detection of periodic signals within video data, specifically utilizing unsupervised learning approaches. Conventionally, video analysis has predominantly relied on supervised learning techniques, which necessitate extensive annotated datasets to train models effectively. The task of annotating video data is labor-intensive and can be particularly challenging in contexts where human expertise is either unavailable or in situations where privacy concerns hinder data labeling.

In known methodologies, the detection of periodic signals in video data typically requires the intervention of human annotators to create labeled datasets. These methods often depend on predefined patterns or signatures established from prior knowledge, limiting adaptability to new or unforeseen patterns. Furthermore, such methods may struggle in dynamic environments where periodic events manifest with variability in timing or appearance, necessitating frequent retraining of models to maintain performance.

The advent of machine learning, specifically neural networks, has enabled advancements in video analysis by allowing for nuanced pattern recognition. Nonetheless, existing machine learning solutions generally rely heavily on supervised training, which imposes significant burdens related to data curation and labeling. The constraints associated with these traditional techniques underline a need for more adaptable systems capable of operating effectively without extensive pre-labeled data.

What is needed is an approach that allows for the autonomous identification of periodic signals within video data without the necessity of labeled training datasets. Accordingly, the inventors provide the desired solution that utilizes unsupervised learning techniques to automatically discern recurrent patterns within diverse video inputs, thus overcoming the limitations of current supervised methods and extending application possibilities. This would be particularly beneficial in scenarios with limited access to annotated datasets, a need for real-time analysis, or when faced with novel or evolving video content.

Camera-based vitals estimation is a rapidly growing field enabling non-contact health monitoring in a variety of settings (e.g., surveillance, border or gate control, deception detection, medical diagnostics, and multimedia entertainment. Although many of the signals avoid detection from the human eye, video data (e.g., visible infrared, etc.) contain subtle intensity changes caused by physiological oscillations such as blood volume and respiration. Significant remote photoplethysmography (rPPG) research for estimating the cardiac pulse has leveraged supervised deep learning for robust signal extraction. While the number of successful approaches has rapidly increased, the size of benchmark video datasets with simultaneous vitals recordings has remained relatively stagnant.

Robust deep learning-based systems for deployment require training on larger volumes of video data with diverse skin tones, lighting, camera sensors, and movement. However, collecting simultaneous video and physiological ground truth with contact-PPG or electrocardiograms (ECG) is challenging for several reasons. First, many hours of high-quality videos is an unwieldy volume of data. Second, recording a diverse subject population in conditions representative of real-world activities is difficult to conduct in the lab setting. Finally, synchronizing contact measurements with video is technically challenging, and even contact measurements used for ground truth contain noise.

Fortunately, recent works find that contrastive unsupervised learning for rPPG is a promising solution to the data scarcity problem. With end-to-end unsupervised learning collecting more representative training data to learn powerful visual features is much simpler, since only video is required without associated medical information. However, the contrastive methods do not incorporate prior information on periodic signals into the framework, and typically require a dataset of multiple subjects to form negative pairs.

In the embodiments, weak assumptions of periodicity can be sufficient for learning the minuscule visual features corresponding to the blood volume pulse from unlabeled face videos. The loss functions can be computed in the frequency domain over batches without the need for pairwise or triplet comparisons.

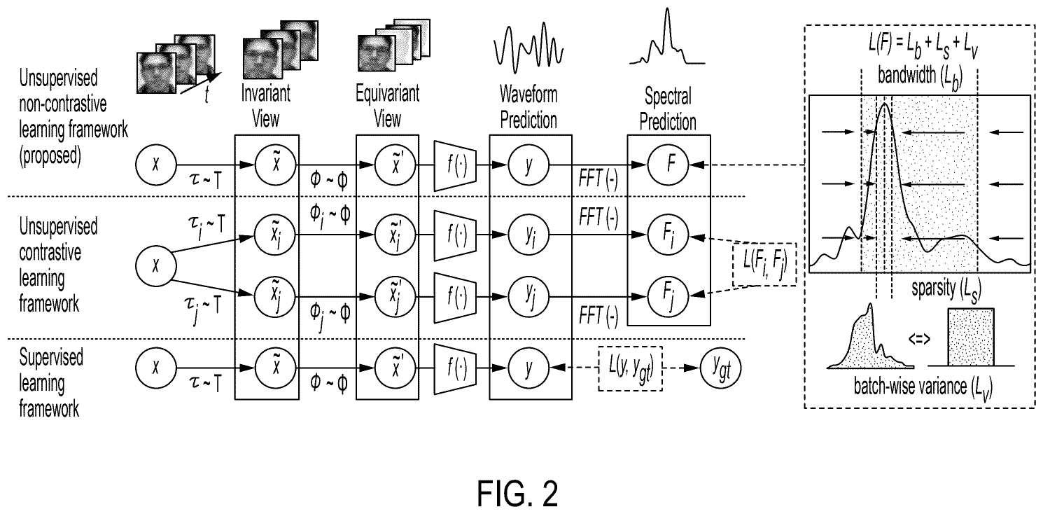

FIG. 2 illustrates an overview of a non-contrastive unsupervised learning (SiNC) framework compared with traditional supervised and unsupervised learning. It has been shown that the SiNC approach can be readily generalized to other domains such as respiratory signals from video by changing the bandlimits in the loss formulation. Additionally, while most unsupervised deep learning approaches are created with the intention of training on easily gathered large-scale datasets, SiNC can be used for finetuning on a single short segment of video from one person. This expands applications to privacy-aware, personalized, and adaptive models in remote physiological sensing.

As illustrated in FIG. 2, supervised and contrastive losses use distance metrics to the ground truth or other samples. The loss is applied directly to the prediction by shaping the frequency spectrum, and encouraging variance over a batch of inputs. Power outside of the bandlimits is penalized to learn invariances to irrelevant frequencies. Power within the bandlimits is encouraged to be sparsely distributed near the peak frequency.

At the outset, first formulate signal regression from video. A video sample xᵢ∈R^{T×W×H×C} sampled from a dataset D consists of T images of size W×H pixels across C channels, captured over time. State-of-the-art methods offer models f that regress a waveform R^{T} [symbol] yᵢ=f(xᵢ) of the same length as the video. Recently, the task has been effectively modeled end-to-end with the models f being spatiotemporal neural networks. While most previous works are supervised and minimize the loss to a contact physiological measurement, the various embodiments use non-contrastive learning using only the model's estimated waveform.

Significantly, strong priors can be placed on the estimated pulse regarding its bandwidth and periodicity. Observed signals outside the desired frequency range are pollutants, so penalizing the model for carrying them through the forward pass results in invariances to such noisy visual features. Desired constraints can be readily applied in the frequency domain. Thus, all waveforms are transformed into their discrete Fourier components with the FFT before computing all losses in the approach. Specifically, calculate power spectral density as F=|FFT(y)|². For example, set the input signal's length to achieve a frequency resolution of 0.33 bpm (i.e., the n or nfft variable in some packages was set to 5,400). The loss functions and augmentations used during training will now be described.

One of the advantages of unsupervised learning for periodic signals is that the solution space is constrained significantly. For physiological signals such as respiration and blood volume pulse, the healthy upper and lower bounds of the frequencies are known. It is desired that the extracted signal be sparse in the frequency domain, and that that model filters out noise signals present in the video. With these constraints, the problem of finding good features for the desired signal in the data is simplified.

Bandwidth Loss. One of the most powerful constraints that can be placed on the model is frequency bandlimits. Known unsupervised methods have used the irrelevant power ratio (IPR) as a validation metric for model selection. The IPR penalizes the model for generating signals outside the desired bandlimits. With lower and upper bandlimits of a and b, respectively, the bandwidth loss becomes:

$${L}_{b} = \frac{1}{{\sum }_{i = - ∞}^{∞} {F}_{i}} [ {\sum }_{i = - ∞}^{a} {F}_{i} + {\sum }_{i = b}^{∞} {F}_{i} ] ,$$

where Fᵢ is the power in the ith frequency bin of the predicted signal. This loss enforces learning of many invariants, such as movement from respiration, talking, or facial expressions which typically occupy low frequencies. For example, limits such as a=0.66 Hz to b=3 Hz may be specified, which corresponds to a common pulse rate range from 40 bpm to 180 bpm.

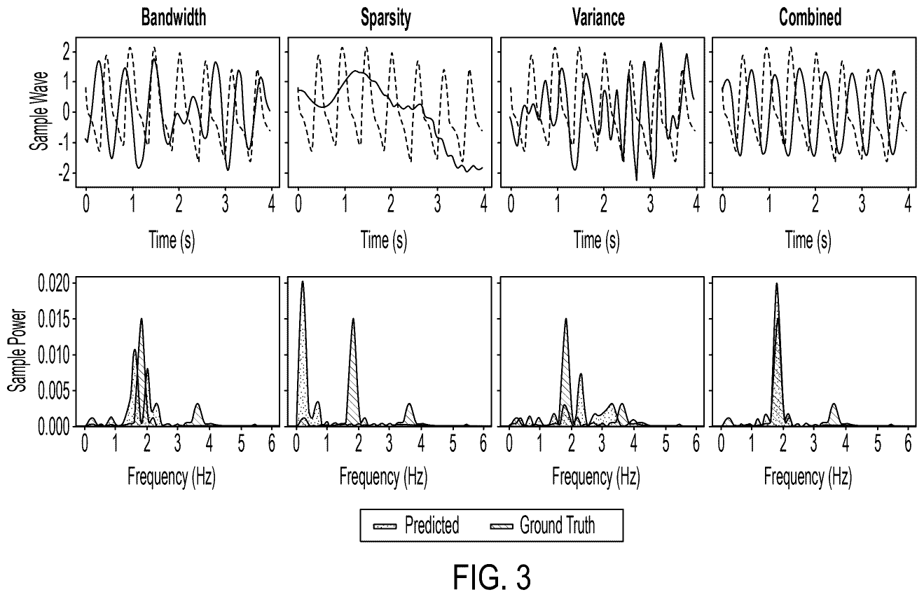

FIG. 3 illustrates model predictions. As shown in FIG. 3, each column shows predictions from models trained with one or all of the losses for 20 epochs on UBFC-rPPG. The first two rows show a sample in the time and frequency domain, respectively. The last row shows the signal power over the validation set computed by taking the sum of normalized power spectral densities from each sample, then dividing the result by the number of validation samples. The bandwidth loss penalizes signal power outside predefined bandlimits (40 to 180 bpm) to constrain the output space. The sparsity loss encourages a narrow spectrum containing strong periodicity. The variance loss encourages diverse power spectra in a batch, preventing the model from collapsing to a narrow bandwidth. When combined, the model estimates periodic signals within the desired bandlimits.

The first column of FIG. 3 shows the result of training exclusively with the bandwidth loss Lb. The last row shows that the model concentrates signal power between the bandlimits.

Sparsity Loss. The pulse rate is the most common physiological marker associated with the blood volume pulse. Since the primary interest is in the frequency, the mode can be further improved by preventing wideband predictions. This also reveals the true signal to be discovered by ignoring visual dynamics that are not strongly periodic.

Energy is penalized energy within the bandlimits that are not near the spectral peak according to:

$${L}_{s} = \frac{1}{{\sum }_{i = a}^{b} {F}_{i}} [ {\sum }_{i = a}^{{F}^{*} - {Δ}_{F}} {F}_{i} + {\sum }_{i = {F}^{*} - {Δ}_{F}}^{b} {F}_{i} ] ,$$

where F*=argmax (F) and AF are the frequencies of the spectral peak and padding around the peak, respectively. For all rPPG experiments Δ_{F}=0.1 Hz (or 6 beats per minute). FIG. 3 shows the result of training only with the sparsity loss in the second column. For the whole dataset, the power spectrum is sparsely distributed in the low frequencies, effectively filtering frequencies higher than 1 Hz.

Variance Loss. One of the risks of non-contrastive methods is the model collapsing into trivial solutions and making predictions independently of the input features. In regularized methods such as VICReg, a hinge loss on the variance over a batch of predictions is used to enforce diverse outputs. A similar strategy can be used to avoid model collapse, but instead spread the variance in power spectral densities towards a uniform distribution over the desired frequency band. The variance loss processes a uniform prior distribution P over d frequencies, and a batch of n spectral densities, F=[V₁, . . . , Vₙ], where each vector is a d-dimensional frequency decomposition of a predicted waveform. The normalized sum of densities is calculated over the batch, Q, and the variance loss is defined as the squared Wasserstein distance to the uniform prior:

$${L}_{v} = \frac{1}{d} {\sum }_{i = 1}^{d} {( {CDF}_{i} ( Q ) - {CDF}_{i} ( P ) )}^{2} ,$$

where CDF is a cumulative distribution function. The third column of FIG. 3 shows the effect of the variance loss during training. For a single sample, wide-band signals containing multiple frequencies are predicted, and the predicted frequencies cover the task's bandwidth. For example, a batch size of 20 samples can be used.

Combining All Losses. Summarizing, the training loss function is a sum of the aforementioned losses:

$$L = {L}_{b} + {L}_{s} + {L}_{v} .$$

While one could weight particular components of the loss more than others, losses also can be formulated to scale them between 0 and 1. A simple summation without weighting gives good performance. The combined loss function encourages the model to search over the supported frequencies to discover visual features for a strong periodic signal. Remarkably, this simple framework is sufficient for learning to regress subtle periodic signals such as the blood volume pulse from video, as shown in the last column of FIG. 3.

Several augmentations can be applied to both the spatial and temporal dimensions to learn invariances to noisy visual signals. In fact, without augmentations, the models did not converge during training.

Image Intensity Augmentations. Gaussian noise is added to each pixel with zero mean and a standard deviation of 2 on an image scale from 0 to 255. Each clip is darkened or brightened by adding a constant from a Gaussian distribution with mean 0 and standard deviation of 10.

Spatial Augmentations. For example, randomly horizontally flip a video clip with 50% probability. The spatial dimension of a clip are randomly square cropped down to between half the original length and the original length. The cropped clip is then linearly interpolated back to the original dimensions.

Temporal Augmentations. For example, with the general assumption that the desired signal is strongly periodic and sparsely represented in the Fourier domain, randomly flip a video clip along the time dimension with a probability of 50%. Note that the Fourier decomposition of a time-reversed sinusoid is identical to that of the original sinusoid.

Frequency Augmentations. Perhaps the most significant augmentation is frequency resampling, where the video is linearly interpolated to a different frame rate. This augmentation is particularly interesting for rPPG because it transforms the video input and target signal equivalently along the time dimension, making it equivariant. Given the aforementioned transformations that are invariant, T(·)˜T, the equivariant frequency resampling operation, ϕ(·)˜ϕ, and a model f(·) that infers a waveform from a video we have the following:

$$ϕ ( f ( τ ( x ) ) ) = f ( ϕ ( τ ( x ) ) ) .$$

This is a powerful augmentation, because it allows the augmentation of the target distribution along with the video input. For example, randomly resample input clips by a factor c˜U(0.6, 1.4). After applying the resampling augmentation, scale the bandlimits by c, to avoid penalizing the model if the augmentation pushed the underlying pulse frequency outside of the original bandlimits.

PURE, UBFC-rPPG, and DDPM can be used as benchmark rPPG datasets for training and testing, and CelebVHQ dataset and HKBU-MARs for unsupervised training only. For remote respiration experiments, the MSPM dataset can be used.

Deception Detection and Physiological Monitoring (DDPM) consists of data from 86 subjects attempting to answer questions deceptively. Interviews were recorded at 90 frames-per-second for more than 10 minutes on average. Natural conversation and head pose changes make it a difficult and less-constrained rPPG dataset.

PURE is a benchmark rPPG dataset consisting of 10 subjects recorded over 6 sessions. Each session lasted approximately 1 minute, and raw video was recorded at 30 fps. The 6 sessions for each subject consisted of: (1) steady, (2) talking, (3) slow head translation, (4) fast head translation, (5) small and (6) medium head rotations. Pulse rates are at or close to the subject's resting rate.

UBFC-rPPG contains 1-minute long videos from 42 subjects recorded at 30 fps. Subjects played a time-sensitive mathematical game to raise their heart rates, but head motion is limited during the recording.

HKBU 3D Mask Attack with Real World Variations (HKBU-MARS) consists of 12 subjects captured over 6 different lighting configurations with 7 different cameras each, resulting in 504 videos lasting 10 seconds each. The diverse lighting and camera sensors make it a valuable dataset for unsupervised training. Version 2 of HKBU-MARS was used, which contains videos with both realistic 3D masks and unmasked subjects.

High-Quality Celebrity Video Dataset (CelebV-HQ) is a set of processed YouTube videos containing 35,666 face videos from over 15,000 identities. The videos vary dramatically in length, lighting, emotion, motion, skin tones, and camera sensors. The challenge in harnessing online videos is their reduced quality due to compression before upload and by the video provider. Compression is a known challenge for rPPG, since the blood volume pulse is so subtle optically.

Multi-Site Physiological Monitoring (MSPM) is a large video dataset consisting of 103 subjects with ground truth pulse, blood pressure, and respiration. This dataset is used for remote respiration experiments. The respiration ground truth was collected by having subjects follow a 120 second long video with cues on the screen to inhale and exhale. The breathing frequencies were modulated between 0.167-0.333 Hz (10-20 breaths per minute), which is considered a healthy range for adults. We used the videos from the “RGB Front” camera. The entire video including activities other than the respiration activity was used for training.

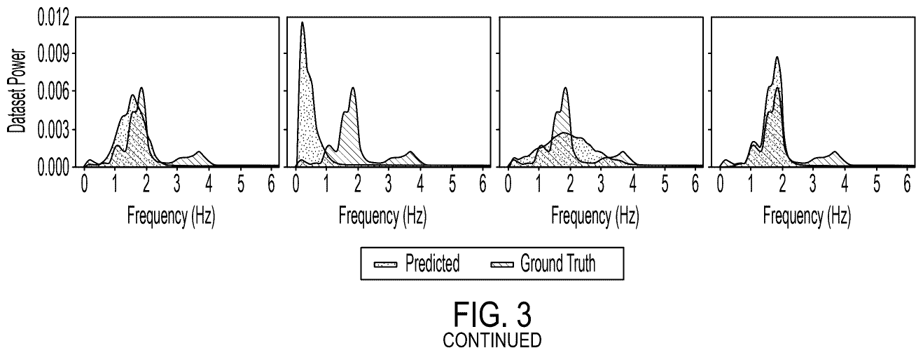

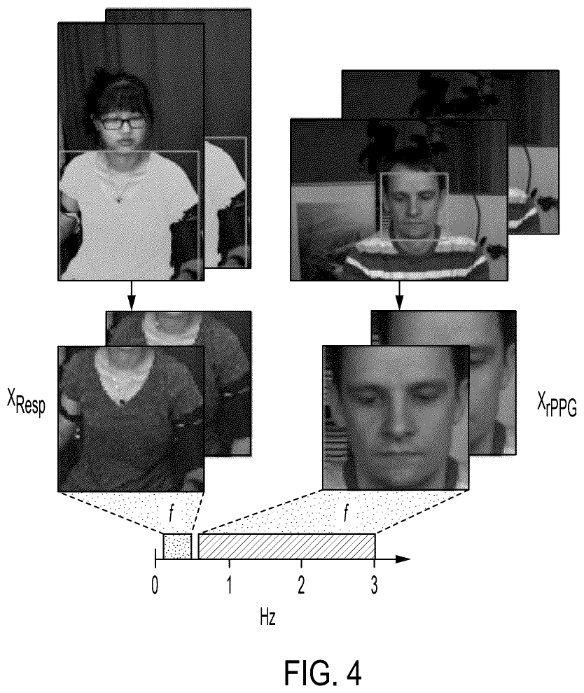

FIG. 4 illustrates preprocessing for remote respiration (left) and pulse estimation (right), along with the bandlimits used during training with SiNC.

rPPG Data Preprocessing. To prepare the video clips for the spatiotemporal deep learning models, first extract 68 face landmarks with OpenFace. Then, define a bounding box in each frame with the minimum and maximum (x, y) locations by extending the crop horizontally by 5% to ensure that the cheeks and jaw are present. The top and bottom are extended by 30% and 5% of the bounding box height, respectively, to include the forehead and jaw. Further, extend the shorter of the two axes to the length of the other to form a square. The cropped frames are then resized to 64×64 pixels with bicubic interpolation. An example of the preprocessing for rPPG is shown on the right side of FIG. 4. For faster processing of the massive CelebV-HQ dataset, instead use MediaPipe Face Mesh for landmarking. For rPPG, each input sample is T=120 frames (4 seconds) in duration.

Model Architectures. A 3D-CNN architecture without temporal dilations was used, which was derived from PhysNet. A temporal kernel width of 5 was used, and default zero-padding was replaced by repeating the edges. Zero-padding along the time dimension can result in edge effects that add artificial frequencies to the predictions. Experiments showed that temporal dilations caused aliasing and reduced the bandwidth of the model to specific frequencies.

The losses and framework can be applied to a variety of tasks and architectures with dense predictions along one or more dimensions. However, popular rPPG architectures such as DeepPhys may be ill-suited for the approach, since they only consume frame differences, and the number of time points should be large enough to give sufficient frequency resolution with the FFT. To show that the embodiments can generalize to different architectures, additional experiments were run with a temporal shift convolutional attention network (TS-CAN) architecture. TS-CAN is a two-stream network that takes RGB frames in one stream to compute attention masks (visual branch) and frame differences in the other where the motion is applied (motion branch). The convolutional operations in TS-CAN are 2-dimensional, making it a relatively lightweight model.

Supervised Training. To properly compare the approach to its supervised counterpart, the same model architecture was used and trained with the commonly used negative Pearson loss between the predicted waveform and the contact sensor ground truth. During training the same augmentations were applied except time reversal. When training the TS-CAN models, only flipping, illumination, and random cropping was used, as it was found that the model could not converge with Gaussian noise or frequency augmentations. The AdamW optimizer was used with a learning rate of 0.0001 for both supervised and unsupervised training. Models are trained for 200 epochs on PURE and UBFC-rPPG, and for 40 epochs on DDPM. The model from the epoch with the lowest loss on the validation set is selected for testing.

Unsupervised Training. Unsupervised models are trained for the same number of epochs as the supervised setting for both PURE and UBFCrPPG, but trained for an additional 40 epochs on DDPM, since this dataset is considerably more difficult. For example, a batch size to 20 samples can be during training. Contrary to previous unsupervised approaches, validation sets for model selection are used by selecting the model with the lowest combined bandwidth and sparsity losses.

Evaluation. Pulse rates are computed as the highest spectral peak between 0.66 Hz and 3 Hz (equivalent to 40 bpm to 180 bpm) over a 10-second sliding window. The same procedure is applied to the ground truth waveforms for a reliable evaluation. Respiration rates are computed as the spectral peak between 0.166 Hz and 0.33 Hz (10-20 breaths per minute) over a 30-second sliding window. Common error metrics such as mean absolute error (MAE), root mean square error (RMSE), and Pearson correlation coefficient (r) can be applied.

A 5-fold cross validation is performed for both PURE and UBFC, and use the predefined dataset splits from DDPM. Three of the folds are used for training, 1 for validation, and the remaining for testing rather than only training and testing partitions. Three models are trained with different initializations, resulting in 15 models trained on PURE and UBFC each, and 3 models are trained on DDPM.

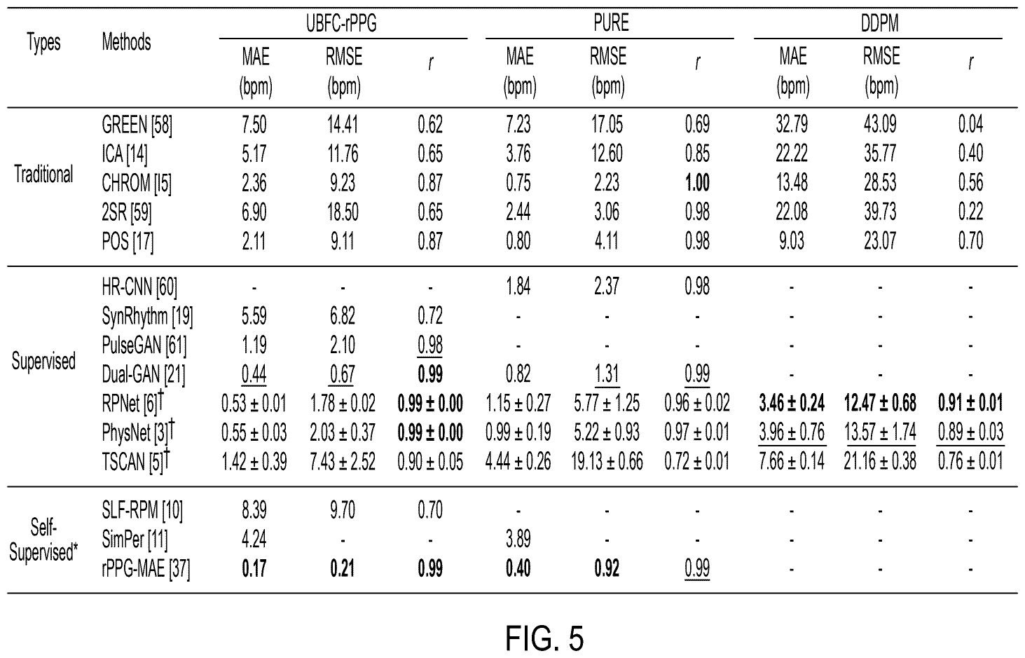

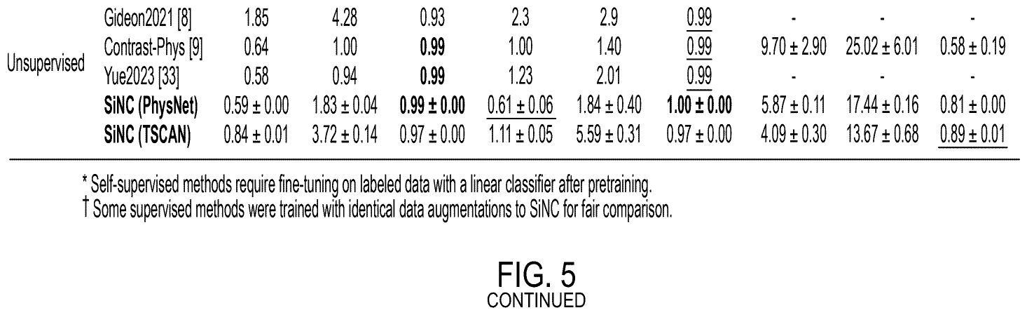

FIG. 5 illustrates the results for models trained and tested on subject-disjoint partitions from the same datasets. The mean and standard deviation of the errors are provided.

For PURE and UBFC, a MAE lower than 1 bpm is achieved, performing better or on par with all traditional and supervised learning approaches. PURE gives the lowest MAE and a Pearson r of nearly 1. Performance drops on DDPM due to the overall difficulty of the dataset. SiNC outperforms contrastive approaches, only being surpassed by supervised deep learning models.

In comparison to other unsupervised methods, Contrast-Phys gives the most competitive performance on all but DDPM. SiNC gives the lowest MAE on all datasets, but has higher RMSE. This may be due to their use of harmonic removal as a post-processing step when estimating the pulse rate.

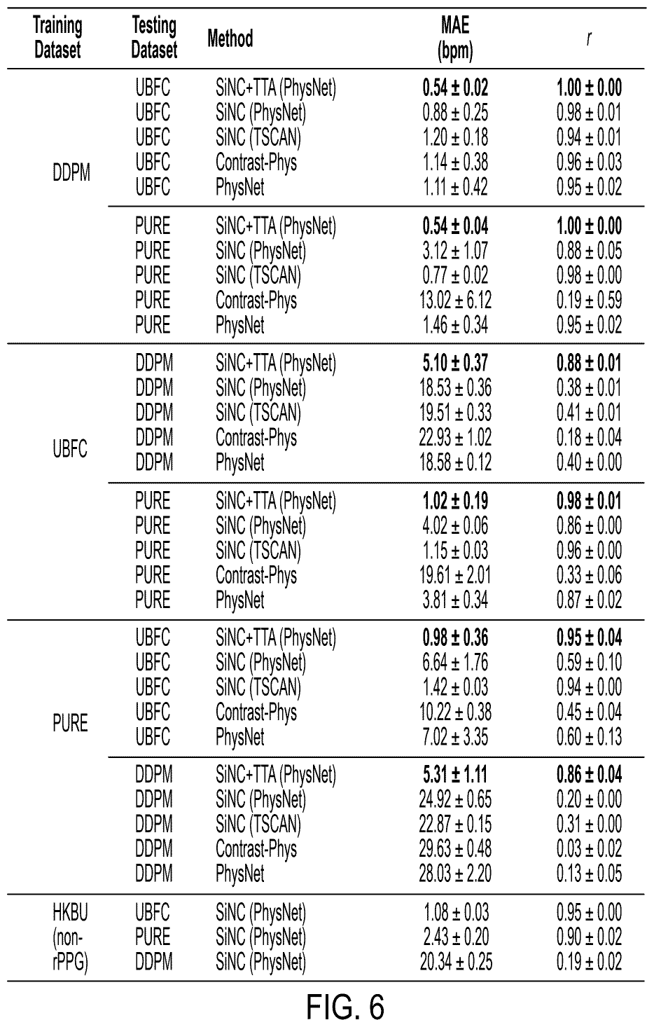

Cross-Dataset Testing. Cross-dataset testing is performed to analyze whether the embodiments are robust to changes to the lighting, camera sensor, pulse rate distribution, and motion. FIG. 6 illustrates the results for SiNC and supervised training with the same architecture. The performance is similar for the supervised and unsupervised approaches when transferring to different data sources. Training on PURE exclusively gives relatively poor results when transferring to UBFC-rPPG and DDPM, due to the low pulse rate variability within PURE samples and lack of movement. Training on DDPM gives the best results overall, since the dataset is the largest and captures larger subjects' movements compared to other datasets.

Training with non-rPPG Datasets. Given the abundance of face videos publicly available online, a model on the CelebV-HQ dataset was trained. After processing the available videos with MediaPipe and resampling to 30 fps, the unlabeled dataset consisted of 34,029 videos. The model was trained for 23 epochs and manually stopped training due to a plateau in the validation loss. Unfortunately, it was found that the model could not converge to the true blood volume pulse. The failure may be attributed to poor video quality from compression.

The HKBU-MARs dataset was designed for face presentation attack detection, but trained models on the “real” video sessions in the dataset. The bottom rows in FIG. 6 shows the results for training on HKBU-MARs, then testing on the benchmark rPPG datasets. Training on HKBUMARs gives better results when testing on UBFC-rPPG and PURE than all training sets except DDPM, which is an order of magnitude larger. This is the first successful experiment showing that non-rPPG videos can be used to train robust rPPG models, even if they do not have ground-truth pulse labels.

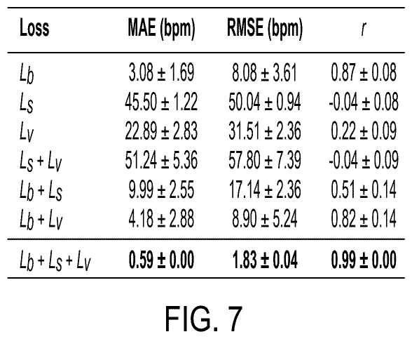

Models were trained using a variety of combinations of loss components to analyze their contributions. FIG. 7 illustrates the results for training and testing on a variety of datasets.

FIG. 7 shows the results for training and testing on UBFC-rPPG. The bandwidth loss is the most critical for discovering the true blood volume pulse, while the sparsity and variance losses do not learn the desired signal by themselves. Surprisingly, combining the bandwidth loss with just one of the sparsity or variance losses gives worse performance than just the bandwidth loss. However, when combining all three components, the model achieves impressive results.

Personalization from pretrained models. A pretrained model can be finetuned on a small amount of unlabeled video from a single subject. In effect, model personalization is executed at the very beginning of the video, then the model is frozen for the remainder of inference on that subject. This is useful in applications where the model cannot generalize well to the unseen subject, camera, lighting, or behavior in the new video during testing. By finetuning the model on the short video sequence of the subject, the model calibrates to the new environmental settings. If the subject continued to use the system, this personalized model may outperform a single all-purpose model.

Validation was achieved using one of the most challenging cross-dataset scenarios, namely training on UBFC and testing on DDPM. For this scenario, both supervised and unsupervised approaches gave MAE values over 18 bpm, leaving ample room for improvement. Specifically, the first 20 seconds of each test subject is used in DDPM as a training set for finetuning a single model. The PhysNet models were trained with SiNC on UBFC from the k-folds experiments as the initial weights. Each model is trained for 50 epochs with a batch size of 20 samples using all but the Gaussian noise and frequency augmentations. Here, an epoch is the number of 120 frame samples that can be made from the 20-second video with a 60-frame overlap. After training, 15 personalized models for each subject were generated in the DDPM test set, since 3 initializations over each of the 5 folds were used.

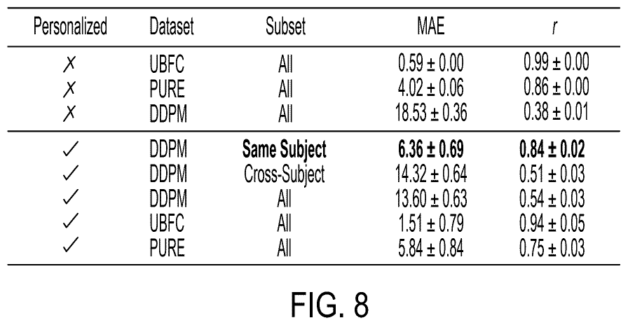

FIG. 8 illustrates the results of training the personalized models. Results on UBFC and PURE show that the model does undergo minor “forgetting”, where the performance on the original UBFC training dataset and PURE degrades. However, personalized models improve drastically when tested on their corresponding subject. The MAE drops by 12.17 bpm down to 6.36 bpm (65.7% reduction) and the Pearson's r correlation jumps from 0.38 to 0.84. In fact, the correlation for the personalized models is higher than the PhysNet models trained with SiNC on the entire DDPM training set.

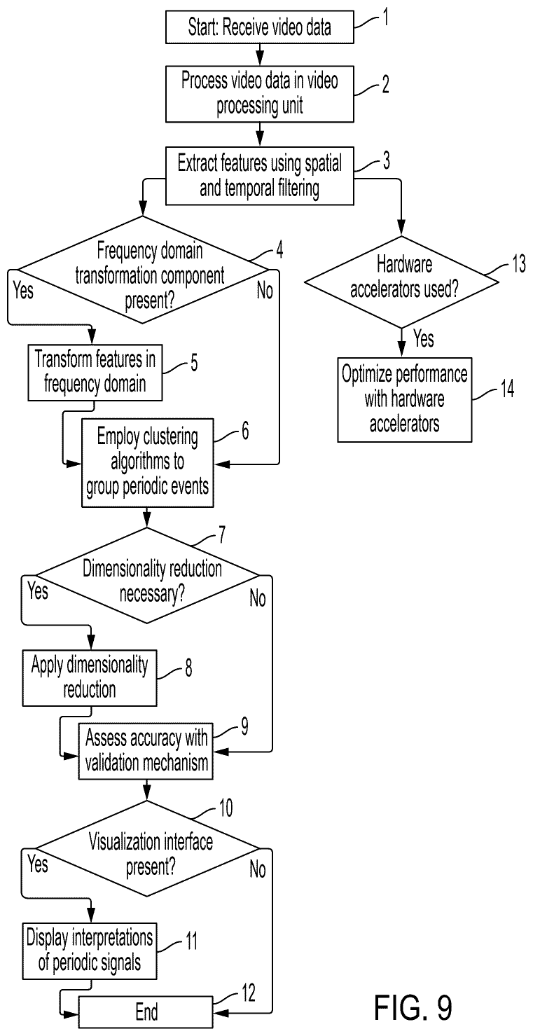

FIG. 9 is a flowchart illustrating a method for detecting periodic signals within video data.

The process begins at step 1, where video data is received. At step 2, the video data is processed using a video processing unit. Features are extracted at step 3 employing spatial and temporal filtering techniques.

The process then diverges based on component availability. At step 4, it is determined whether a frequency domain transformation component is present. If so, at step 5, the features undergo transformation in the frequency domain. Subsequently, at step 6, clustering algorithms are employed to group periodic events.

At step 7, the necessity for dimensionality reduction is assessed. If required, step 8 involves applying dimensionality reduction techniques. The process then advances to step 9, where accuracy is assessed using a validation mechanism.

Further, at step 10, the presence of a visualization interface is determined. If available, step 11 allows for displaying interpretations of periodic signals. The process concludes at step 12.

From step 4, if a frequency domain transformation is not present, the process proceeds to step 13, where the use of hardware accelerators is evaluated. If hardware accelerators are used, step 14 involves optimizing performance with them. This optimization loop integrates back into the main process through clustering and dimensionality reduction.

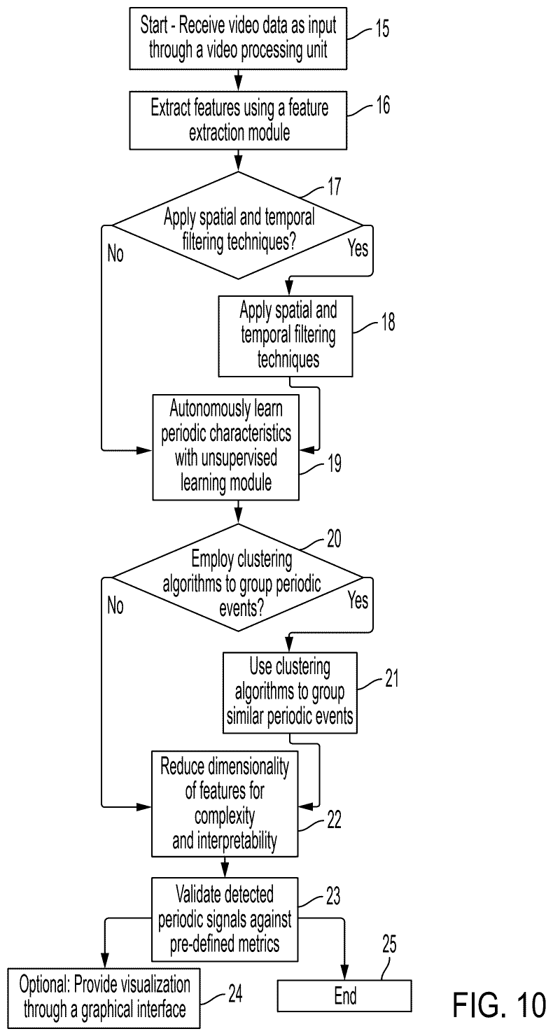

FIG. 10 is a flowchart detailing an alternative implementation of the method for detecting periodic signals within video data.

The process commences at step 15, receiving input video data through a video processing unit. At step 16, features are extracted using a feature extraction module.

Step 17 assesses the application of spatial and temporal filtering techniques. If affirmative, step 18 involves their application. The process subsequently continues to step 19, where an unsupervised learning module autonomously learns periodic characteristics from the data.

At step 20, the need for employing clustering algorithms is evaluated. If needed, step 21 deploys these algorithms to group similar periodic events. Following this, step 22 reduces dimensionality of features for enhanced complexity management and interpretability.

Step 23 involves validating the detected periodic signals against predefined metrics. Subsequently, step 24 optionally offers visualization through a graphical interface, before concluding the process at step 25.

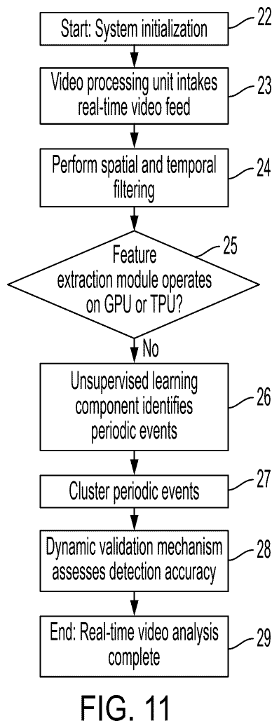

FIG. 11 is a flowchart of a system for real-time video analysis of periodic signals. The sequence initiates at step 26 with system initialization. At step 27, the video processing unit intakes a real-time video feed. Step 28 performs spatial and temporal filtering on this feed. At step 29, the operation of the feature extraction module on either a GPU or TPU is checked. If neither is used, the process advances to step 30, where an unsupervised learning component identifies periodic events. Step 31 clusters these periodic events for analysis. Following this, step 32 involves a dynamic validation mechanism assessing detection accuracy. The process finalizes at step 33, marking the completion of real-time video analysis.

As can be understood from the foregoing, the various embodiments can incorporate a video processing unit that processes video data streams from one or more sources, analyzing them concurrently to identify periodic signals. This concurrent processing capability enhances the system's ability to detect temporal patterns across diverse video inputs. Subtle periodic signals such as blood volume pulse and respiration can be extracted from RGB video, enabling noncontact health monitoring at low cost. Advancements in remote pulse estimation—or remote photoplethysmography (rPPG)—are currently driven by deep learning solutions. However, modern approaches arc trained and evaluated on benchmark datasets with ground truth from contact-PPG sensors. Thus, the inventors have provided the first non-contrastive unsupervised learning framework for signal regression to mitigate the need for labelled video data. With minimal assumptions of periodicity and finite bandwidth, the embodiments identify the blood volume pulse directly from unlabeled videos. Encouraging sparse power spectra within normal physiological band limits and variance over batches of power spectra is sufficient for learning visual features of periodic signals. Unlabeled video data not specifically created for rPPG was used to train robust pulse rate estimators. Given the limited inductive biases, the same approach was successfully applied to camera-based respiration by changing the bandlimits of the target signal. This shows that the approach is general enough for unsupervised learning of bandlimited quasi-periodic signals from different domains. Furthermore, it was shown that the framework is effective for finetuning models on unlabeled video from a single subject, allowing for personalized and adaptive signal regressors.

In the various embodiments, the feature extraction module can utilize a convolutional neural network (CNN) architecture to perform spatial and temporal analysis on video frames, detecting periodic signals with high granularity. The CNN-based module can process each frame independently or in sequence, extracting features that highlight periodicity.

In the various embodiments, the unsupervised learning component can employ a self-organizing map (SOM) for clustering identified periodic signals. The SOM algorithm can automatically group similar signal patterns, which can facilitate further analysis and pattern recognition.

In the various embodiments, the system can include a real-time monitoring module that provides alerts when specific periodic patterns are detected in the video data. The alerts can be delivered via various communication channels, such as mobile notifications or email, enabling users to respond promptly to the identified patterns.

In the various embodiments, a hardware acceleration component could be integrated, incorporating field-programmable gate arrays (FPGAs) to optimize the computational efficiency of signal processing tasks. This component can result in decreased processing latency and increased throughput, particularly beneficial for processing high-resolution or high-frame-rate video data.

In the various embodiments, a graphical interface for visualizations can support dynamic representation of periodic signals, allowing users to interactively explore temporal patterns through tools such as zoom, pan, and annotation. This interactive capability can enhance user engagement and understanding of detected patterns within the video data.

In the various embodiments, the system can be adaptable to various video formats and encodings, including MPEG, H.264, and HEVC, ensuring broad compatibility with existing video content. This adaptability allows the system to function effectively across different video generation and storage environments.

In the various embodiments, the system can employ transfer learning techniques to improve the efficiency of detecting periodic signals in new video datasets. By leveraging pre-trained models, the system can rapidly adapt to new data contexts, reducing the need for extensive retraining and thereby saving time and computational resources.

The embodiments can be used to analyze video feeds at border crossings (e.g., a border check point or security kiosk), access control gates, or other access points to potentially detect physiological signals relevant to security or screening processes. The embodiments of the invention are designed to measure biometrics, including heart rate, respiration rate, blink rate, without physical contact with the subject. These vital signs can provide indicators about a subject's physical psychological state. For example, irregular pulse rates or patterns could potentially flag individuals for further screening, such as in the case of deception detection. The embodiments' ability to perform measurements using a camera sensor without physical contact is a significant advantage for border and gate control. This allows for remote physiological sensing, which can be implemented at checkpoints without requiring individuals to interact directly with physical screening devices.

Accordingly, the embodiments introduce systems, devices, methods, and instructions for autonomously identifying recurring patterns (e.g., pulse, respiration) in video content using unsupervised learning. The embodiments overcome the limitations of traditional supervised methods that require extensive labeled datasets, particularly for detecting subtle periodic signals like heart rate and respiration. The embodiments utilize feature extraction, clustering algorithms, and validation to analyze video data for these temporal patterns, offering potential applications in various fields such as border or gate security, deception detection, healthcare, and entertainment without the need for manual annotation. Experimental results demonstrate the effectiveness of the unsupervised learning framework on several benchmark video datasets, including its ability to adapt to new subjects and data sources.

It will be apparent to those skilled in the art that various modifications and variations can be made in the embodiments of the present invention without departing from the spirit or scope of the invention. Thus, it is intended that the present invention cover the modifications and variations of this invention provided they come within the scope of the appended claims and their equivalents.

I/We claim:

1. A system for detecting periodic signals within video data, comprising:
a video processing unit configured to receive video data as input;
a feature extraction module configured to analyze frames of the video data to identify patterns indicative of periodicity, the feature extraction module comprising spatial and temporal filtering components; and
an unsupervised learning module to identify and group one or more periodic events based.

2. The system of claim 1, wherein the feature extraction module further comprises a frequency domain transformation component to derive features indicative of repeated events.

3. The system of claim 1, wherein the unsupervised learning module further includes a dimensionality reduction component to manage computational complexity and improve data interpretability.

4. The system of claim 1, further comprising a visualization interface for displaying interpretations of detected periodic signals.

5. The system of claim 1, wherein the system is implemented at a border crossing.

6. The system of claim 1, wherein the system is implemented at an access control point.

7. A method for detecting periodic signals within video data, comprising:
receiving video data as input through a video processing unit;
extracting features from frames of the video data using a feature extraction module to identify patterns indicative of periodicity; and
autonomously learning periodic characteristics from the extracted features using an unsupervised learning module.

8. The method of claim 7, wherein extracting features comprises applying spatial and temporal filtering techniques.

9. The method of claim 7, wherein autonomously learning involves employing clustering algorithms to group similar periodic events.

10. The method of claim 7, further comprising reducing dimensionality of the features to manage computational complexity and improve interpretability.

11. The method of claim 7, further comprising providing a visualization of the detected periodic signals through a graphical interface.

12. The method of claim 7, wherein the video data comprises surveillance footage, medical imaging, or multimedia content.

13. The method of claim 7, wherein the video data comprises video of a border crossing or an access control point.

14. A system for real-time video analysis of periodic signals, comprising:
a video processing unit configured to intake real-time video feed;
a hardware-accelerated feature extraction module configured to perform spatial and temporal filtering on the video feed;
an unsupervised learning component configured to identify and group periodic events within the video feed; and
a dynamic validation mechanism for continuous assessment of periodic event detection accuracy.

15. The system of claim 14, wherein the hardware-accelerated feature extraction module operates on a GPU or TPU for enhanced performance.
